(19) United States
(12) Patent Application Publication
(10) Pub. No.: US 2018/0145379 A1
(43) Pub. Date: May 24, 2018

(54) METHOD AND APPARATUS TO CONTROL TEMPERATURE OF BATTERY

(71) Applicant: SAMSUNG ELECTRONICS CO., LTD., Suwon-si (KR)

(72) Inventors: Kaeweon YOU, Hwaseong-si (KR); SangDo PARK, Seoul (KR)

(73) Assignee: SAMSUNG ELECTRONICS CO., LTD., Suwon-si (KR)

(21) Appl. No.: 15/585,889

(22) Filed: May 3, 2017

(30) Foreign Application Priority Data
Nov. 21, 2016 (KR) 10-2016-0155159

(51) Int. Cl. H01M 10/48; H01M 10/613; H01M 10/615; H02J 7/04

(52) U.S. Cl. CPC H01M 10/486; H02J 7/041; H01M 10/615; H01M 10/613

(57) ABSTRACT

Provided is a method and apparatus to control a temperature of a battery. The method and the apparatus are configured to acquire states of health (SOHs) of modules of a battery, acquire a reference temperature of a representative module among the modules based on the SOHs, and control a temperature of the battery based on the reference temperature.

### CROSS-REFERENCE TO RELATED APPLICATION(S)

This application claims the benefit under 35 USC § 119(a) of Korean Patent Application No. 10-2016-0155159 filed on Nov. 21, 2016, in the Korean Intellectual Property Office, the entire disclosure of which is incorporated herein by reference for all purposes.

### BACKGROUND

### 1. Field

The following description relates to an apparatus and method to control a temperature of a battery.

### 2. Description of Related Art

A battery is used to supply power or as a power source for electronic devices, such as a mobile device, and an electric vehicle. As the number of users of an electric vehicle or a mobile device including the battery increases, a desire for an advanced battery control technology is increasing. In terms of a battery control, managing or controlling and monitoring a battery temperature may have a significant effect on a battery condition. Operating the battery at a temperature that is higher or lower temperature than an optimal operational temperature may accelerate an aging of the battery.

A sensor attached to a predetermined position inside the battery may be used to monitor and control the temperature of the battery. In a scheme to monitor and control the temperature of the battery using the sensor, a static temperature control may be performed based on a predetermined sensing point at the position in which the sensor is located. As a result, a deviation in temperature between modules of the battery may not be properly monitored in the battery temperature control. The deviation in temperature between the modules of the battery may cause degradation in the battery. Accordingly, there is a desire for temperature control technology to minimize the degradation in the battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a method to control a temperature of a battery, the method including: acquiring states of health (SOHs) of modules of a battery; acquiring a reference temperature of a representative module among the modules based on the SOHs; and controlling a temperature of the battery based on the reference temperature.

The controlling of the temperature of the battery may include: comparing the reference temperature to an upper threshold temperature; and reducing the temperature of the battery based on a comparison result.

The controlling of the temperature of the battery may include: comparing the reference temperature to a lower threshold temperature; and increasing the temperature of the battery based on a comparison result.

The controlling of the temperature of the battery may include controlling temperatures of the modules collectively to adjust the reference temperature to be within a temperature range.

The controlling of the temperature of the battery may include controlling either one or both of a temperature and a flow rate of a flow channel affecting temperatures of the modules to adjust the reference temperature to be within a temperature range.

The acquiring of the SOHs may include: measuring currents and voltages of the modules; and estimating the SOHs based on the currents and the voltages.

The acquiring of the reference temperatures may include selecting the reference module corresponding to a minimum SOH from the SOHs.

The acquiring of the reference temperature may include estimating the reference temperature based on a current and a voltage of the reference module.

The acquiring of the reference temperature may include measuring a temperature of the reference module.

The acquiring of the SOHs may include estimating the SOHs based on SOHs of cells included in each of the modules.

The acquiring of the reference temperature may include estimating the reference temperature based on temperatures of cells included in the reference module.

The method may also include: comparing a standard deviation of the SOHs to a threshold; and determining whether the reference temperature may be to be acquired based on a comparison result.

In accordance with an embodiment, there is provided a non-transitory computer-readable storage medium storing instructions that, when executed by a processor, cause the processor to perform the method described above.

In accordance with an embodiment, there is provided an apparatus to control a temperature of a battery, the apparatus including: a processor configured to acquire states of health (SOHs) of modules of the battery, acquire a reference temperature of a representative module among the modules based on the SOHs, and control a temperature of the battery based on the reference temperature.

The processor may be configured to compare the reference temperature to an upper threshold temperature and reduce the temperature of the battery based on a comparison result.

The processor may be configured to compare the reference temperature to a lower threshold temperature and increase the temperature of the battery based on a comparison result.

The processor may be configured to collectively control temperatures of the modules to adjust the reference temperature to be within a temperature range.

The processor may be configured to control either one or both of a temperature and a flow rate of a flow channel affecting temperatures of the modules to adjust the reference temperature to be in within a temperature range.

The processor may be configured to measure currents and voltages of the modules and estimate the SOHs based on the currents and the voltages.

The processor may be configured to select the reference module corresponding to a minimum SOH from the SOHs.

In accordance with another embodiment, there is provided a battery temperature control method, including: measuring currents and voltages of modules of a battery to estimate a state of health (SOH) of the modules; selecting a representative module amongst the modules as a module corresponding to a minimal SOH among SOHs of the modules included in the battery; and controlling a temperature of the battery based on the minimal SOH as a reference temperature to reduce battery degradation.

The method may further include: comparing a standard deviation of the SOHs of the modules to a threshold and, in response to the standard deviation being greater than the threshold, the processor acquires the reference temperature.

The method may further include: controlling at least one of a temperature or a flow rate of a flow channel affecting the temperatures of the modules and adjusts the reference temperature to be within a temperature range.

The method may further include: comparing the reference temperature to an upper limit temperature of a temperature range and, in response to the reference temperature being greater than the upper limit temperature, decreases temperatures of each module by a difference between the reference temperature and an upper limit temperature of the temperature range.

The method may further include: comparing the reference temperature to a lower limit temperature of a temperature range and, in response to the reference temperature being less than the lower limit temperature, increases the temperatures of each module by a difference between the reference temperature and a lower limit temperature of the temperature range.

The modules may be configured in series, in parallel, or in a matrix form in the battery.

Other features and aspects will be apparent from the following detailed description, the drawings, and the claims.

### BRIEF DESCRIPTION OF THE DRAWINGS

FIG. 1 illustrates an example of a method to control a temperature of a battery.

FIG. 2A illustrates an example of a battery.

FIG. 2B illustrates an example of a portion of the battery of FIG. 2A.

FIG. 3A illustrates an example of a method to control a temperature of the battery of FIG. 2A.

FIG. 3B illustrates a further example of a method to control the temperature of the battery of FIG. 2A.

FIG. 4A illustrates another example of a method to control a temperature of a battery.

FIG. 4B illustrates a further example of a method to control the temperature of the battery.

FIG. 5 illustrates an example to control modules in a battery.

FIG. 6 illustrates another example of a method to control a temperature of a battery.

FIG. 7 illustrates an example of an apparatus to control a temperature of a battery.

FIG. 8 illustrates an example of an apparatus to control a temperature of a battery.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Hereinafter, examples will be described in detail with reference to the accompanying drawings, and like reference numerals in the drawings refer to like elements throughout.

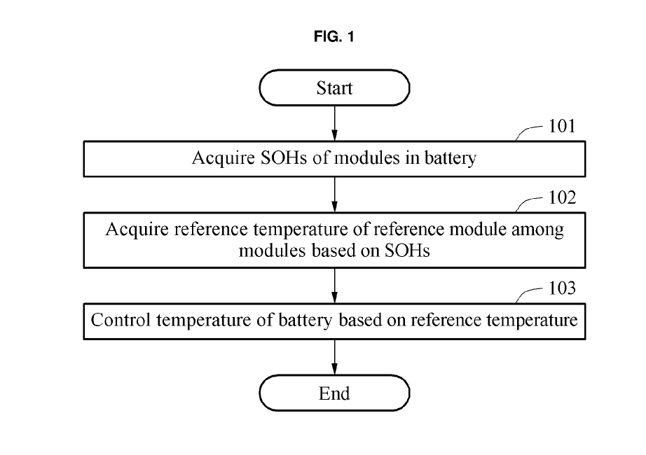

FIG. 1 illustrates an example of a method to control a temperature of a battery.

Referring to FIG. 1, in operation 101, a battery temperature control apparatus acquires states of health (SOHs) of at least one module in a battery. The module may be a storage module, a processor, a measuring device, or a Global System for Mobile communication (GSM) module. In an example, acquiring the SOHs of modules in the battery includes directly measuring or estimating the SOHs of the modules, or acquiring measured or estimated SOHs of the modules. In one embodiment, the measuring or the estimation of the SOHs is done for each of the modules. However, the measuring or the estimation of the SOHs may be performed for a predetermined number of modules, particular locations in the battery, without departing from the intended embodiments described herein. The battery includes a charger or a secondary cell configured to store power as the battery charges, and a device onto which the battery is mounted or installed supplies the power from the battery to a load. The load is an electronic or electric device that consumes the power supplied from an external source. For example, the load includes an electric heater, a light, a motor of an electric vehicle, and similar devices, that consume the power using a circuit in which current flows at a predetermined voltage.

The battery temperature control apparatus is an apparatus that controls a temperature of the battery, and is configured as a hardware module, or a combination thereof. For example, the battery temperature control apparatus may be configured as a battery management system (BMS). The BMS is a system, processor, or controller that manages the battery, and for example, monitors a state of the battery, maintains an optimal condition for an operation of the battery, predicts a replacement timing of the battery, detects a fault of the battery, generates a control signal or a command signal associated with the battery, and controls the state or the operation of the battery.

The SOH is a parameter that quantitatively indicates a change in a battery life characteristic of the battery by an aging effect, for example, a degradation phenomenon. The SOH indicates a level of degradation in the battery life or capacity of the battery. A variety of schemes may be employed when the battery temperature control apparatus estimates a state of charge (SOC) and the SOH. The SOC indicates an available capacity expressed as a percentage of some reference, sometimes its rated capacity or current (i.e. at the latest charge-discharge cycle) capacity. The SOC is an absolute measure in Coulombs, kWh or Ah of the energy left in the battery. In an example, the SOC reference is a rated capacity of a new battery or a current capacity of the battery. The battery temperature control apparatus measures a current and a voltage of the module of the battery and estimates the SOH of the module based on the measured current and voltage. The battery temperature control apparatus estimates the SOH of the module based on SOHs of cells included in the module. The battery temperature control apparatus measures a current and a voltage of the cell of the battery and estimates the SOH of the cell based on the measured current and voltage.

The battery includes cells. A cell is a unit of an element or a device to store power. For example, the battery includes cells arranged in series or in parallel. The battery includes modules. The modules may be arranged in series or in parallel, and may each include a group of cells.

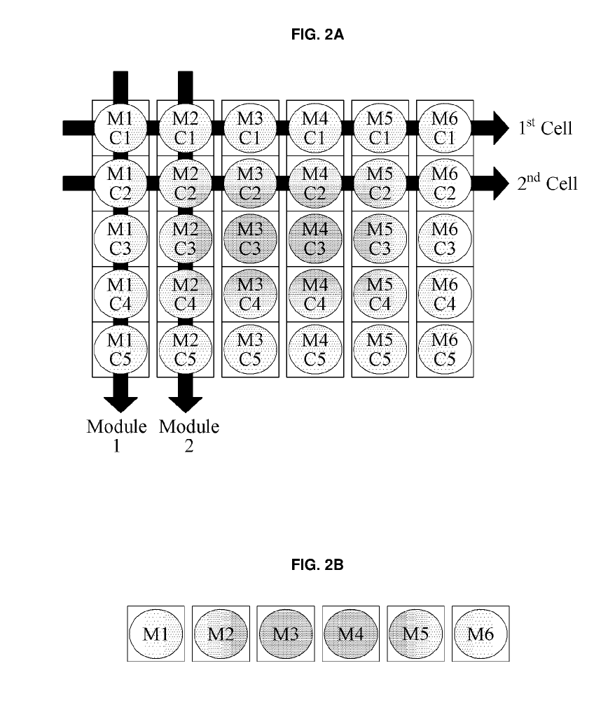

Referring to FIG. 2A, a battery includes modules, for example, a module M1 through a module M6. Each of the modules includes cells, for example, a cell C1 through a cell C5. In an example of 2A, the battery includes 5*6 cells. Although the modules and cells are arranged in a matrix form, other arrangements may be made. Referring to FIG. 2B, the battery is provided as a set of modules, for example, the module M1 through the module M6, each representing the corresponding cells.

In an embodiment, the battery, corresponding to a target of which a temperature is to be controlled, includes at least one of a battery pack including at least one battery module. The at least one battery module includes at least one battery cell. A representative module represents a plurality of battery modules or the at least one battery module. A representative cell represents a predetermined number of battery cells or the at least one battery cell in the representative module. Hereinafter, it is understood that the battery indicates the aforementioned examples.

In FIG. 2A, the cells or the modules included in the battery have different temperatures. For example, the temperatures of the cells or the modules may increase in response to the battery being operated. In this example, based on an arrangement, such as a matrix arrangement, of the cells or the modules, cells or modules located in a central area of the matrix have temperatures higher than those of cells or modules located in an edge area. Referring to FIG. 2A, to illustrate the difference in temperatures, the cells or the modules located in the central area are represented in a stronger shade when compared to the cells or the modules located in the each area. In FIG. 2A, an increase in strength of the shade indicates an increase in the temperature.

Referring to FIG. 2B, this figure illustrates a portion or a third row of the modules illustrated in FIG. 2A. In one example, the third row of the modules is selected as including at least one module with a highest temperature sensed or is selected as being a middle row of the matrix of the modules. In FIG. 2B, temperatures of modules including cells increase toward a center. For example, temperatures of the module M3 and the module M4 are at higher temperatures than temperatures of the module M1 and the module M6. The temperatures of the modules each include a representative value of temperatures of the cells included in each of the modules.

The battery temperature control apparatus estimates degradation states of the modules or the cells of the battery, for instance, of the representative module or the representative cell, and dynamically controls or manages the temperature of the battery. The battery temperature control apparatus adaptively updates a sensing point, for instance, of the representative module or the representative cell, to manage the temperature of the battery and controls the temperature of the battery based on the updated sensing point to reduce a speed of degradation in the battery. The battery temperature control apparatus enhances a life characteristic of the battery using a scheme of acquiring at least one temperature of the modules or the cells based on the SOHs of the modules or the cells of the battery and controlling the temperature of the battery based on the acquired temperature.

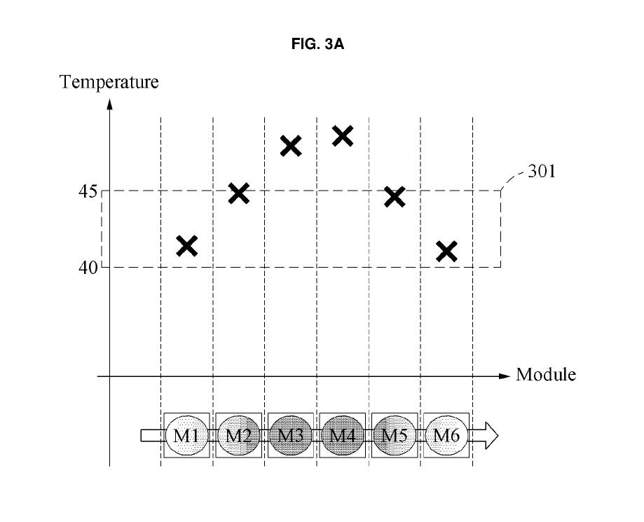

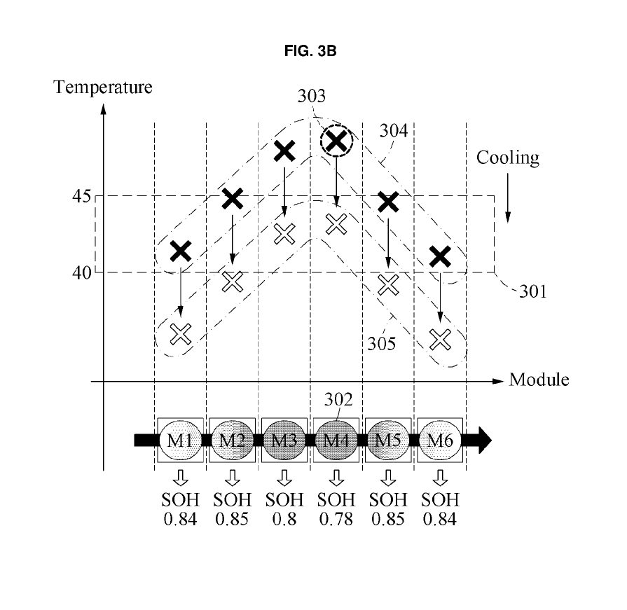

Hereinafter, an example to control the temperature of the battery based on the SOHs and the temperatures of the modules of the battery will be described with reference to FIGS. 3A through 5. The following example is also applicable to an operation to control the temperature of the battery based on the SOHs and the temperatures of the cells of the battery and an operation to control the temperature of the battery based on an SOH and a temperature of at least one cell or an SOH and a temperature of at least one module. Also, embodiments are not limited to aspects of the cells or the modules.

Referring back to FIG. 1, in operation 102, the battery temperature control apparatus acquires a reference temperature of a reference module or the representative module among the modules of the battery based on the SOHs of the modules. The representative module is a module referenced to control the temperature of the battery. The following description will be provided based on an example in which the representative module is a single module, at a center of a battery, for example. However, the representative module may include a plurality of reference modules and the number of reference modules varies depending on examples. The reference temperature is a temperature of the representative module. In an embodiment, acquiring the temperature of the module of the battery includes measuring or estimating the temperature of the representative module, or acquiring a measured or estimated temperature.

Various schemes may be employed when the battery temperature control apparatus estimates the temperature. For example, the battery temperature control apparatus measures a current and a voltage of the module of the battery and estimates the temperature of the representative module based on the measured current and voltage. The battery temperature control apparatus measures the temperature of the representative module using a temperature sensor or acquires a temperature measured by a sensor. The battery temperature control apparatus measures the temperature of the representative module based on the temperatures of the cells included in the representative module. The battery temperature control apparatus measures the current and the voltage of the cells in the representative module and estimates the temperature of the cells based on the measured current and the voltage of the cells.

The battery temperature control apparatus selects the representative module as a module corresponding to a minimal SOH among the SOHs of the modules included in the battery. The battery temperature control apparatus controls the temperature of the battery based on the minimal SOH as a reference temperature so as to reduce the speed of degradation in the battery.

In accord with an embodiment, prior to selecting the representative module, the battery temperature control apparatus includes an SOH estimator configured to compare a standard deviation of the SOHs of the battery to a threshold. The battery temperature control apparatus determines whether to acquire the reference temperature based on a comparison result. For example, the battery temperature control apparatus acquires the reference temperature in response to the standard deviation being greater than the threshold. Also, the battery temperature control apparatus does not acquire the reference temperature in response to the standard deviation being less than the threshold. In response to the standard deviation being greater than the threshold, the battery temperature control apparatus controls the temperature of the battery.

In operation 103, the battery temperature control apparatus controls the temperature of the battery based on the reference temperature of the representative module. The battery temperature control apparatus adjusts the reference temperature to be in an appropriate temperature range to control the temperature of the battery. The appropriate temperature range may be set as a range from a lower limit temperature to an upper limit temperature, and may indicate a temperature range through which the at least one module or the at least one cell of the battery is stably operated. When the module or the cell of the battery is beyond the appropriate range, the at least one module or the at least one cell may be exposed to a condition of accelerating the degradation.

Referring to FIG. 3A, a battery temperature control apparatus selects a module from modules to be a representative module, and adjusts a reference temperature of the representative module to be in an appropriate temperature range 301. FIG. 3 illustrates the appropriate temperature range 301 as a range from 40 degrees Celsius (° C.) to 45° C., and a range of temperature may also vary depending on examples.

Referring to FIG. 3B, the battery temperature control apparatus selects a module M4 corresponding to a minimal SOH of SOHs of modules M1 through M6 to be a reference module or a representative module 302, as being with highest temperature or furthest from the temperature range 301. The battery temperature control apparatus controls, for example, cools by collectively reducing temperatures 304 of the modules and adjusts a reference temperature 303 of the representative module 302 to be in the appropriate temperature range 301. For example, the battery temperature control apparatus compares the reference temperature 303 to an upper limit temperature of the appropriate temperature range 301, and reduces the temperatures 304 of the modules in the battery in response to the reference temperature 303 being greater than the upper limit temperature. The battery temperature control apparatus reduces the temperatures 304 of each module by a difference between the reference temperature 303 and the upper limit temperature of the temperature range 301. In response to the controlling, temperatures 305 of the modules are adjusted to be less than the temperatures 304 of the modules.

The battery temperature control apparatus controls at least one of a temperature or a flow rate of a flow channel affecting the temperatures of the modules and adjusts the reference temperature 303 to be in the appropriate temperature range 301. For example, in a battery of a structure in which a single flow channel affects the temperatures of the modules, the battery temperature control apparatus controls the flow channel by collectively reducing the temperatures 304 of the modules when the reference temperature 303 is greater than the upper limit temperature.

Various methods and schemes may be employed when the battery temperature control apparatus controls the temperature of the battery based on the reference module 302. For example, the battery temperature control apparatus controls independent flow channels to control the temperatures of the modules. In this example, the battery temperature control apparatus individually controls the temperatures of the modules. In terms of a structure in which temperatures of modules are controlled individually, the battery temperature control apparatus individually manages modules having temperatures being beyond the appropriate temperature range 301.

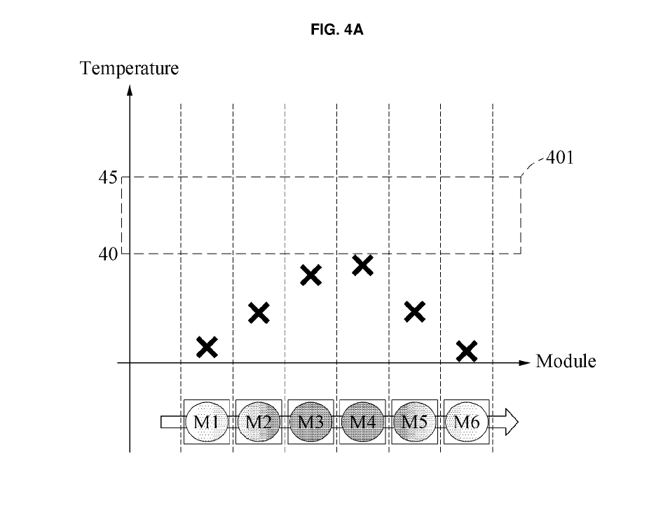

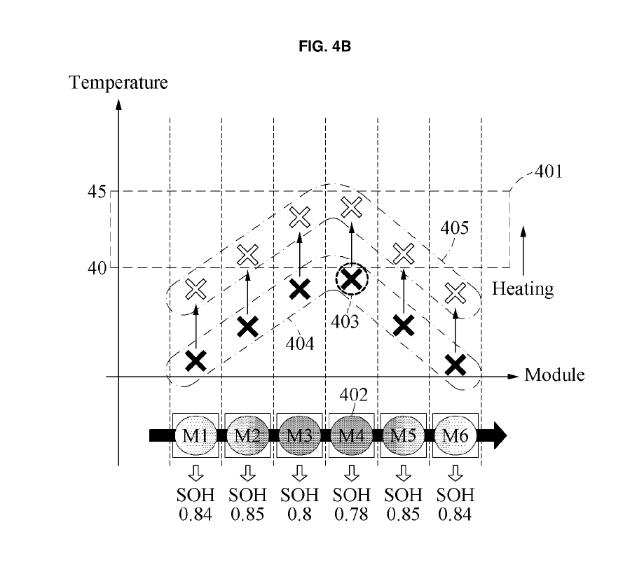

Referring to FIG. 4A, the battery temperature control apparatus selects a module from modules to be a reference module or a representative module, and adjusts a reference temperature of the reference module to be in an appropriate temperature range 401. The foregoing descriptions are also applicable to the appropriate temperature range 401.

Referring to FIG. 4B, the battery temperature control apparatus selects a module M4 corresponding to a minimal SOH of SOHs of modules M1 through M6 to be a reference module of a representative module 402. The battery temperature control apparatus controls, for example, heats to collectively increase temperatures 404 of the modules and adjusts a reference temperature 403 of the representative module 402 to be in the appropriate temperature range 401. For example, the battery temperature control apparatus compares the reference temperature 403 to a lower limit temperature of the appropriate temperature range 401, and increases the temperatures 404 of the modules in the battery when the reference temperature 403 is less than the lower limit temperature. In response to the controlling, temperatures 405 of the modules are adjusted to be greater than the temperatures 404 of the modules.

The battery temperature control apparatus controls at least one of a temperature or a flow rate of a flow channel affecting the temperatures of the modules and adjusts the reference temperature 403 to be in the appropriate temperature range 401. For example, in a battery in which a single flow channel affects the temperatures of the modules, the battery temperature control apparatus controls the flow channel by collectively increasing the temperatures 404 of the modules when the reference temperature 403 is less than the lower limit temperature. As the foregoing, various methods and schemes may be employed when the battery temperature control apparatus controls the temperature of the battery based on the reference module 402.

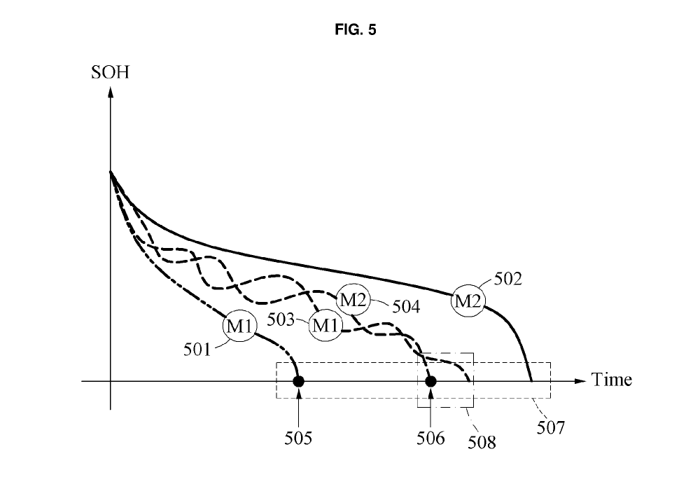

FIG. 5 illustrates an example to control modules in a battery.

Referring to FIG. 5, a phenomenon that SOHs of modules in a battery decreases over time is represented by a graph. In the graph, M1 and M2 denote the modules. When a battery temperature control is statically performed based on one of modules 501 and 502, for example, the module 502, a battery life 505 is defined as a point in time at which an SOH of the module 501, which is not determined to be a static control target, reaches zero.

The battery temperature control apparatus controls the temperature of the battery based on SOHs and temperatures of modules 503 and 504 using the aforementioned methods. For example, when the temperature of the battery is controlled based on the foregoing example, the SOHs of the modules 503 and 504 decrease at similar speeds and a battery life 506 is defined as a point in time at which the SOH of one of the modules 503 and 504 reaches zero. The battery temperature control apparatus reduces a difference between lives of the modules 503 and 504 based on the foregoing example, so as to increase the battery life. A difference 508 between the modules 503 and 504 under a dynamic control may be less than a difference 507 between the modules 501 and 502 under a static control.

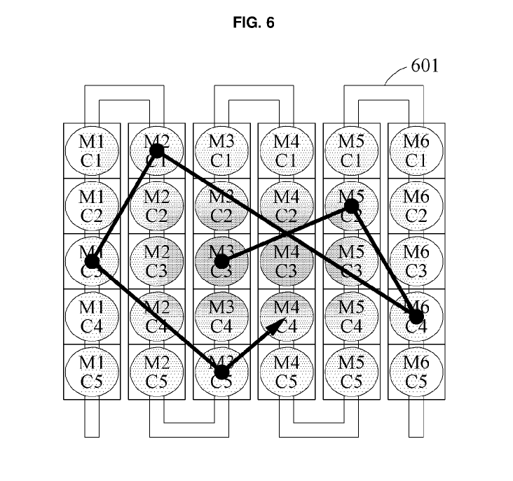

FIG. 6 illustrates another example of a method to control a temperature of a battery.

Referring to FIG. 6, a battery temperature control apparatus adaptively updates a reference cell to control a temperature of a battery based on SOHs of cells included in a battery. As discussed above, the battery temperature control apparatus controls a flow channel 601 and controls the temperature of the battery. The dynamic control based on SOHs of modules described with reference to FIGS. 1 through 5 is applicable to a dynamic control based on the SOHs of the cells. For example, the battery temperature control apparatus changes the reference cell or the representative cell to control the temperature of the battery over time and controls the temperature of the battery based on the representative cell varying over time to reduce a difference between speeds of degradation in the cells of the battery.

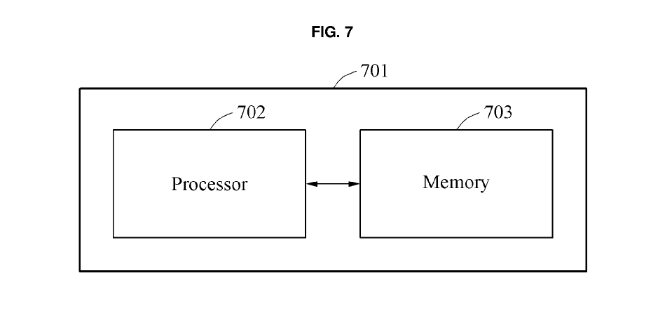

FIG. 7 illustrates an example of an apparatus to control a temperature of a battery.

Referring to FIG. 7, a battery temperature control apparatus 701 includes a processor 702 and a memory 703. The processor 702 includes one or more devices described with reference to FIGS. 1 through 6. Also, the processor 702 performs at least one of methods described with reference to FIGS. 1 through 6. The memory 703 stores a program in which a method to control a temperature of a battery is implemented. The memory 703 is a volatile memory or a non-volatile memory.

The processor 702 executes the program and controls the battery temperature control apparatus 701. A code of the program executed by the processor 702 is stored in the memory 703. The battery temperature control apparatus 701 is connected to an external electronic device, for example, a personal computer (PC) or a network through an input and output device (not shown) to perform a data exchange.

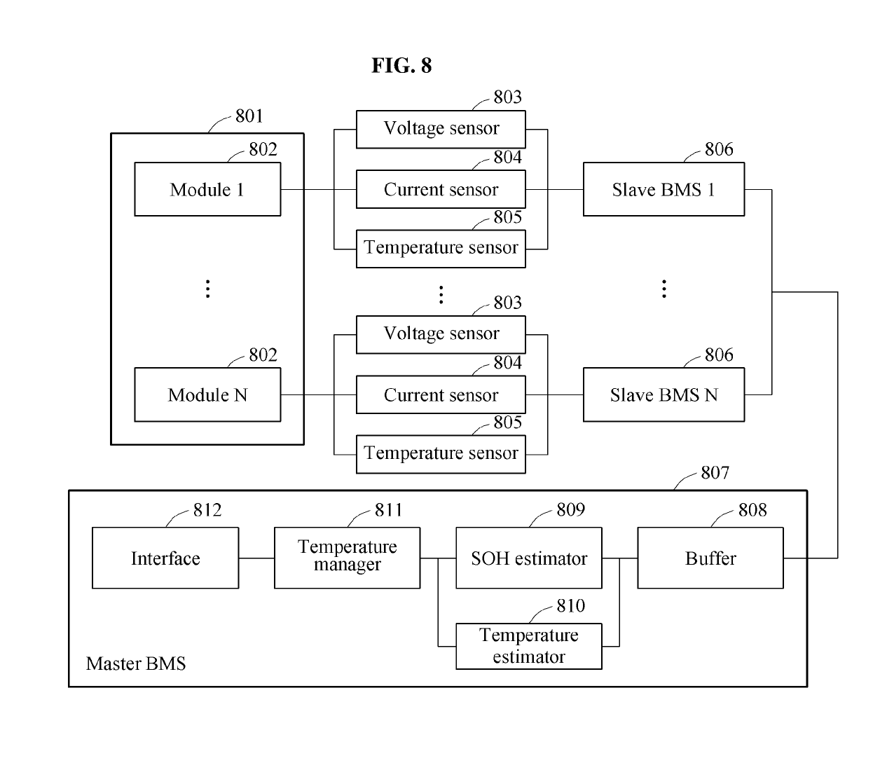

FIG. 8 illustrates an example of a battery temperature control apparatus.

Referring to FIG. 8, a battery temperature control apparatus is implemented as a master battery management system (BMS) 807. The master BMS 807 includes one or more devices described with reference to FIGS. 1 through 7. Also, the master BMS 807 performs at least one method described with reference to FIGS. 1 through 7. A battery 801 includes modules 802. Voltage sensors 803 measure voltages of the modules 802. Current sensors 804 measure currents of the modules 802. Temperature sensors 805 measure temperatures of the modules 802. Slave BMSs 806 preprocess or process information measured by the aforementioned sensors, and then transmit the information to the master BMS 807. The master BMS 807 is a main BMS configured to control and instruct the slave BMSs 806, and the slave BMSs 806 are subordinate BMSs operating based on commands or instructions of the master BMS 807.

A buffer 808 records information transmitted from an external source of the master BMS 807. An SOH estimator 809 loads the information recorded in the buffer 808 and estimates SOHs of the modules 802 or cells. A temperature estimator 810 loads the information recorded in the buffer 808 and estimates the temperatures of the modules 802 or cells. A temperature manager 811 manages or controls a temperature of the battery based on the estimated SOHs and the estimated temperatures. The master BMS 807 outputs control information through an interface 812. The battery temperature control method is implemented by the slave BMSs 806 and the sensors illustrated herein may be omitted depending on examples. The structural elements illustrated herein are merely an example to execute the battery temperature control method. Among the elements, at least one element may be excluded or elements not shown in the drawings may also be equipped to implement the foregoing examples.

The modules, cells, estimators, sensors, managers, and buffer in FIGS. 2A, 2B, 5, and 7-8 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1, 3A through 4B, and 6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method to control a temperature of a battery, the method comprising:
acquiring states of health (SOHs) of modules of a battery;
acquiring a reference temperature of a representative module among the modules based on the SOHs; and
controlling a temperature of the battery based on the reference temperature.

2. The method of claim 1, wherein the controlling of the temperature of the battery comprises:
comparing the reference temperature to an upper threshold temperature; and
reducing the temperature of the battery based on a comparison result.

3. The method of claim 1, wherein the controlling of the temperature of the battery comprises:
comparing the reference temperature to a lower threshold temperature; and
increasing the temperature of the battery based on a comparison result.

4. The method of claim 1, wherein the controlling of the temperature of the battery comprises controlling temperatures of the modules collectively to adjust the reference temperature to be within a temperature range.

5. The method of claim 1, wherein the controlling of the temperature of the battery comprises controlling either one or both of a temperature and a flow rate of a flow channel affecting temperatures of the modules to adjust the reference temperature to be within a temperature range.

6. The method of claim 1, wherein the acquiring of the SOHs comprises:
measuring currents and voltages of the modules; and
estimating the SOHs based on the currents and the voltages.

7. The method of claim 1, wherein the acquiring of the reference temperatures comprises selecting the reference module corresponding to a minimum SOH from the SOHs.

8. The method of claim 1, wherein the acquiring of the reference temperature comprises estimating the reference temperature based on a current and a voltage of the reference module.

9. The method of claim 1, wherein the acquiring of the reference temperature comprises measuring a temperature of the reference module.

10. The method of claim 1, wherein the acquiring of the SOHs comprises estimating the SOHs based on SOHs of cells included in each of the modules.

11. The method of claim 1, wherein the acquiring of the reference temperature comprises estimating the reference temperature based on temperatures of cells included in the reference module.

12. The method of claim 1, further comprising:
comparing a standard deviation of the SOHs to a threshold; and
determining whether the reference temperature is to be acquired based on a comparison result.

13. A non-transitory computer-readable storage medium storing instructions that, when executed by a processor, cause the processor to perform the method of claim 1.

14. An apparatus to control a temperature of a battery, the apparatus comprising:
a processor configured to
acquire states of health (SOHs) of modules of the battery,
acquire a reference temperature of a representative module among the modules based on the SOHs, and
control a temperature of the battery based on the reference temperature.

15. The apparatus of claim 14, wherein the processor is configured to compare the reference temperature to an upper threshold temperature and reduce the temperature of the battery based on a comparison result.

16. The apparatus of claim 14, wherein the processor is configured to compare the reference temperature to a lower threshold temperature and increase the temperature of the battery based on a comparison result.

17. The apparatus of claim 14, wherein the processor is configured to collectively control temperatures of the modules to adjust the reference temperature to be within a temperature range.

18. The apparatus of claim 14, wherein the processor is configured to control either one or both of a temperature and a flow rate of a flow channel affecting temperatures of the modules to adjust the reference temperature to be in within a temperature range.

19. The apparatus of claim 14, wherein the processor is configured to measure currents and voltages of the modules and estimate the SOHs based on the currents and the voltages.

20. The apparatus of claim 14, wherein the processor is configured to select the reference module corresponding to a minimum SOH from the SOHs.

21. A battery temperature control method, comprising:
measuring currents and voltages of modules of a battery to estimate a state of health (SOH) of the modules;
selecting a representative module amongst the modules as a module corresponding to a minimal SOH among SOHs of the modules included in the battery; and
controlling a temperature of the battery based on the minimal SOH as a reference temperature to reduce battery degradation.

22. The method of claim 21, further comprising:
comparing a standard deviation of the SOHs of the modules to a threshold and, in response to the standard deviation being greater than the threshold, the processor acquires the reference temperature.

23. The method of claim 21, further comprising:
controlling at least one of a temperature or a flow rate of a flow channel affecting the temperatures of the modules and adjusts the reference temperature to be within a temperature range.

24. The method of claim 21, further comprising:
comparing the reference temperature to an upper limit temperature of a temperature range and, in response to the reference temperature being greater than the upper limit temperature, decreases temperatures of each module by a difference between the reference temperature and an upper limit temperature of the temperature range.

25. The method of claim 21, further comprising:
comparing the reference temperature to a lower limit temperature of a temperature range and, in response to the reference temperature being less than the lower limit temperature, increases the temperatures of each module by a difference between the reference temperature and a lower limit temperature of the temperature range.

26. The method of claim 21, wherein the modules are configured in series, in parallel, or in a matrix form in the battery.
